(19) United States
(12) Patent Application Publication
(10) Pub. No.: US 2014/0340757 A1
(43) Pub. Date: Nov. 20, 2014

(54) MIRROR ASSEMBLY

(71) Applicant: GM Global Technology Operations LLC, Detroit, MI (US)

(72) Inventors: Charles R. Quinn, Pleasant Ridge, MI (US); John Martuscelli, Shelby Township, MI (US)

(73) Assignee: GM Global Technology Operations LLC, Detroit, MI (US)

(21) Appl. No.: 13/895,414

(22) Filed: May 16, 2013

(51) Int. Cl. B60R 1/00

(52) U.S. Cl. CPC B60R 1/006
USPC 359/629

(57) ABSTRACT

A mirror assembly includes a mirror pane and a head cap. The mirror pane generally faces a first direction. The head cap has a first region and a second region. The first region generally faces a second direction and the second region generally faces a third direction. The first region and the second region may both be formed from transparent materials. The first region is substantially covered by a first coating having a first reflectance and a first transmittance. The first reflectance is less than one hundred percent and the first transmittance is greater than zero, such that light passes through the first region and the second region and is visible from the interior of the vehicle.

### TECHNICAL FIELD

This disclosure relates to mirror assemblies and housings for vehicles, particularly side view or wing mirrors.

### BACKGROUND

Vehicles may include one or more mirrors to expand the area viewable to drivers or operators. Generally, rear view mirrors help the driver see behind the vehicle and side view mirrors help the driver see behind and to the side, or to both sides, of the vehicle.

### SUMMARY

A mirror assembly, such as those used on vehicles, is provided. The mirror assembly includes a mirror pane and a head cap. The mirror pane generally faces rearward, relative to the vehicle and the head cap generally faces forward from the mirror pane.

The head cap has a first region or first panel and a second region or second panel. The first region generally faces forward, relative to the vehicle, and the second region generally faces an interior of the vehicle. The first region and the second region may both be formed from transparent materials.

The first region is substantially covered by a first coating having a first reflectance and a first transmittance. The first reflectance is less than one hundred percent and the first transmittance is greater than zero, such that light passes through the first region and the second region and is visible from the interior of the vehicle.

The above features and advantages, and other features and advantages, of the present invention are readily apparent from the following detailed description of some of the best modes and other embodiments for carrying out the invention, which is defined solely by the appended claims, when taken in connection with the accompanying drawings.

### BRIEF DESCRIPTION OF THE DRAWINGS

FIG. 1 is a schematic top view diagram of a vehicle having mirror assemblies on the left and right sides;

FIG. 2 is schematic isometric view of a driver viewpoint looking through the right side mirror assembly; and

FIG. 3 is a schematic isometric view of a mirror assembly having two arms connecting the assembly to the vehicle.

### DETAILED DESCRIPTION

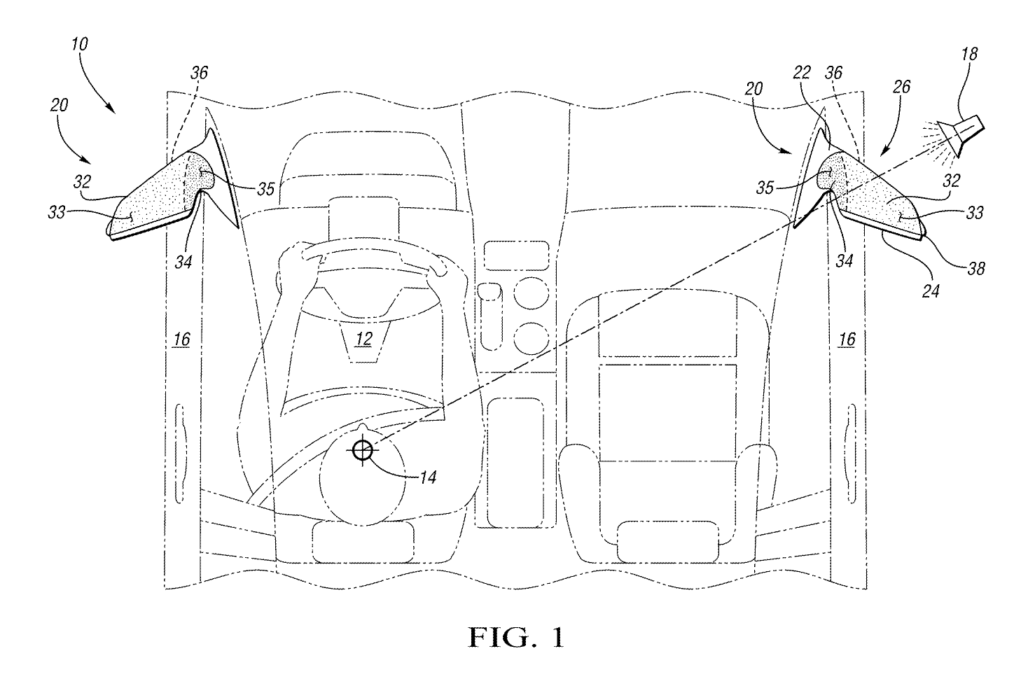

Referring to the drawings, like reference numbers correspond to like or similar components wherever possible throughout the several figures. FIG. 1 shows a schematic diagram of the top a portion of a vehicle 10. A driver's seat 12 illustrates the general location of the driver or primary operator of the vehicle 10. Note that although the driver's seat 12 is illustrated on the left side (left-hand drive) of the vehicle 10, the structures and methods described herein apply equally to vehicles with the driver's seat 12 on the right side (right-hand drive) and to vehicles in which the driver's seat 12 is located in the center.

While the present invention may be described with respect to automotive or vehicular applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims. Any numerical designations, such as “first” or “second” are illustrative only and are not intended to limit the scope of the invention in any way.

Features shown in one figure may be combined with, substituted for, or modified by, features shown in any of the figures. Unless stated otherwise, no features, elements, or limitations are mutually exclusive of any other features, elements, or limitations. Any specific configurations shown in the figures are illustrative only and the specific configurations shown are not limiting of the claims or the description. All elements may be mixed and matched between figures.

A viewpoint 14 generally illustrates the location of the driver's head within the vehicle 10. One or more doors 16 generally illustrate the separation between the interior and exterior of the vehicle 10. An exterior point 18 illustrates both one possible viewpoint from the exterior of the vehicle 10 and one possible location of a light source shining toward the vehicle 10.

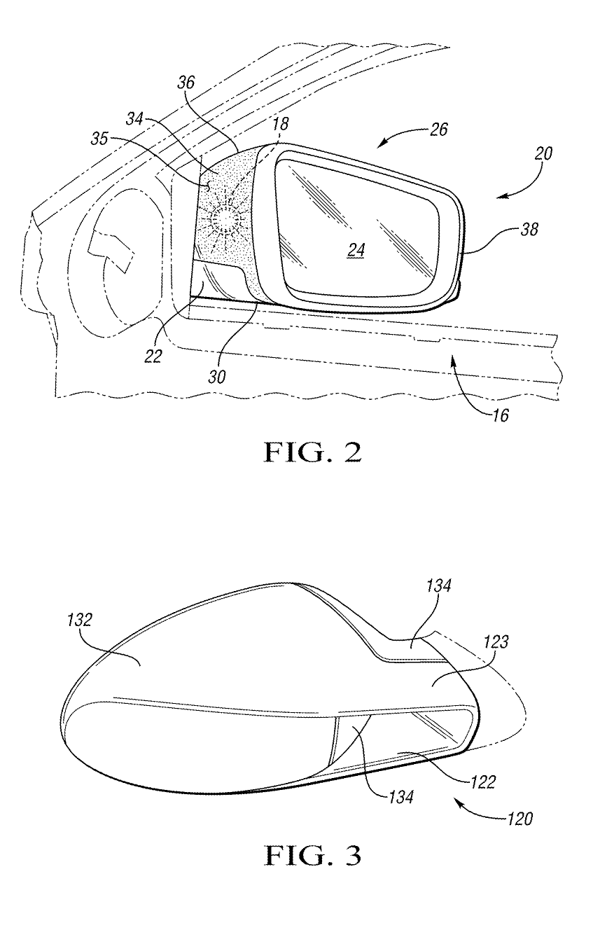

The vehicle 10 includes at least one mirror assembly 20. In the view shown in FIG. 1, there is one mirror assembly 20 on each side, left and right, of the vehicle 10. Referring also to FIG. 2, and with continued reference to FIG. 1, there is shown an isometric view of the right side mirror assembly 20, as viewed from approximately the viewpoint 14 or the driver's seat 12.

An arm 22 connects the mirror assembly 20 to the vehicle 10. The arm 22 usually connects the mirror assembly 20 to one of the doors 16, but may also connect to structure forward of the doors 16. A mirror pane 24 faces a first direction from the mirror assembly 20, which may be referred to as the rearward direction, relative to the vehicle 10, from the mirror assembly 20. The mirror pane 24 provides rear and side views to the viewpoint 14.

A housing 26, or a head cap, generally surrounds and protects the mirror pane 24. Much of the housing 26 is forward of the mirror pane 24, relative to the vehicle 10. The housing 26 may include components that mechanically or electro-mechanically vary the angle of the mirror pane 24 relative to the viewpoint 14.

The arm 22 creates an offset between the vehicle 10 and the housing 26. As discussed herein, some configurations of the mirror assembly 20 may have two arms 22. The housing 26 is configured to be transparent or semi-transparent from the inside-out (i.e., from the viewpoint 14) but reflective from the outside-in (i.e., from the exterior point 18). Therefore, the mirror assembly 20 provides forward and side visibility to the driver of the vehicle 10 through a portion of the housing 26 and provides rearward and side visibility via the mirror pane 24.

The arm 22 may have a base portion or base plate 30 to support the housing 26. Alternatively, a portion of the housing 26 may define the base plate 30, which is the lower portion of the mirror assembly 20. Much of the housing 26 is formed from a transparent material. However, the base plate 30 need not be formed from a transparent material if the base plate 30 is a separate component and is not formed as one piece with the remainder of the housing 26. Therefore, the base plate 30 may be opaque.

Transparent materials are clear, such that a viewer can see through them as if there is little or nothing between the viewer and objects on the other side of the transparent material. Objects can be discerned with great detail through transparent materials. However, translucent materials allow light to pass, but with significant diffusion or distortion, such that objects on the other side of the translucent material are obscured.

Opaque materials substantially block the transmission of light through the material and, as such, do not allow the viewer to see objects on the other side of the opaque material. Note that transparent materials may be tinted or colored.

The housing 26 includes a first region 32, which faces a second direction relative to the vehicle 10 or the housing 26. The second direction is generally forward and outward, relative to the vehicle 10. Numerical designations, such as first, second, and third, are illustrative and only used to designate that different directions or areas exist. In some configurations of the housing 26, the first region 32 is formed from a first panel. Alternatively, the first region 32 may simply be part of a one-piece housing 26. If the first region 32 is formed from its own first panel, the first panel is formed from a transparent material.

A first coating 33 substantially covers the first region 32. The first coating 33 has a first reflectance. For example, and without limitation, the first coating 33 may be a thin layer of chrome or aluminum. The first reflectance of the first coating 33 is less than one hundred percent, such that some light passes from the exterior point 18 through the first region 32 toward the viewpoint 14. Alternatively stated, transmittance or light transmission through the first region 32 is greater than zero. The mirror assembly 20 is configured to allow the operator of the vehicle 10, seated at or near the viewpoint 14, to see light passing through the mirror housing 26.

Reflectance or reflectivity is the ratio of the total amount of light reflected by thin coatings to the total amount of light incident on the surface. Transmission or transmittance is the ratio of the total amount of light that transparent objects allow to pass through the object. Absorption or absorptance is the ratio of the total amount of light value that objects neither reflect nor transmit through the object. Many objects exhibit a combination of light reflectance, absorption, and transmission. As used herein, it is assumed that the response of light incident on any specific sample may generally be expressed as a combination of reflectance, absorptance, and transmittance.

Transparent materials allow significant transmission of light through the material, such that the transmittance is much greater than zero, but transparent materials may still have absorptance. Opaque materials have absorptance of nearly one hundred percent, such that any incident light not reflected away from the material is absorbed by the opaque material.

When reflection occurs on thin layers of material, such as the reflective coatings used on mirrors, the relative amounts of reflectance versus transmittance may be changed by varying the coating thickness. Reflectance will approach the material's maximum possible value as the coating becomes thicker. Similarly, in reflective coatings, the transmittance of the coating will approach zero as the coating becomes thicker. Measured reflectance of a thin coating may also be affected by the base material to which the coating is applied.

The housing 26 also includes a second region 34 facing a third direction, which is toward an interior of the vehicle 10. The second region 34 is viewable from the viewpoint 14. The second region 34 may be formed from a second panel or may be part of a one-piece housing 26, such that the first region 32 and the second region 34 are part of a single, one-piece element. If the second region 34 is formed from a separate panel, the second panel is formed from a transparent material. Whether the second region 34 is formed as a separate panel or as part of a one-piece housing 26, light passes through the first region 32 and the second region 34 from the exterior point 18 to the viewpoint 14 within the vehicle 10.

The second region 34 of the housing 26 may include a second coating 35 having a second reflectance, which substantially covers the second region 34, or the second region 34 may be uncoated. The second reflectance is lower than the first reflectance. The second reflectance may be a property of the second coating 35 or of the transparent material alone.

Alternatively, there may be a single coating with a gradient transition to define the first region 32 and the second region 34, such as by varying the thickness of the coating to have higher reflectance in the first region 32 than the second region 34. Reflectance of the first coating 33 and either the uncoated second region 34 or the second coating 35 refers to the visible light spectrum.

The combined effects of the first coating 33 on the first region 32 and the second region 34 allow light to pass from the exterior point 18, through the housing 26, to the viewpoint 14. Therefore, the driver may be able to see light that would be blocked by the mirror assembly 20 if the housing 26 were opaque or the first region 32 had maximum reflectance—which may approach one hundred percent—and minimum transmittance, such that the first coating 22 were instead completely reflective. However, because the first region 32 has the first coating 33, someone standing at the exterior point 18 will see the first region 32 as reflective and, in most lighting conditions, will not see through the first region 32 into or beyond the housing 26.

Note that the second region 34 may or may not have the second coating 35. If the second coating 35 is used, it may be beneficial for the second reflectance to be less than the first reflectance. Otherwise, the driver may not be able to see light from the exterior point 18 through the second region 34.

The combined, or total, reflectance of the first coating 33, the first region 32, the second coating 35 (if present), and the second region 34 is less than one hundred percent and transmittance is greater than zero, such that light can pass through the housing 26. Therefore, measuring or testing reflectance of the portion of the housing 26 between the exterior point 18 and the viewpoint 14 would yield a value between zero and the maximum possible value for the first coating 33.

A crest or ridge 36 may generally identify the border or transition between the first region 32 and the second region 34. The ridge 36 acts to divide the portions of the housing 26 that are seen from the viewpoint 14, as opposed to those blocked from view. If the first region 32 and the second region 34 are formed from individual first and second panels, the two panels may meet or be joined at the ridge 36.

The mirror assembly 20 may also have a trim panel 38 extending from the housing 26 to shade and protect the mirror pane 24. The trim panel 38 may be formed as one piece with the remainder of the housing 26 or may be a separate component.

Generally, the reflectance of the first coating 33 and the second coating 35, if present, is measured based upon the visible light spectrum. This promotes visibility by the driver at the viewpoint 14. However, the first coating 33 and the second coating 35 may be tuned to allow passage of specific types of light. For example, and without limitation, the first coating 33 and the second coating 35 may be tuned to reflect most light but to allow light from the headlights of other vehicles to pass through the housing 26. Furthermore, the first coating 33 or the second coating 35 may be polarized, such that only light waves having a particular orientation are allowed to pass through the housing 26.

Referring now to FIG. 3, and with continued reference to FIGS. 1-2, there is shown an isometric view of a mirror assembly 120. Unlike the mirror assembly 20, which had only one arm 22, the mirror assembly 120 has a first arm 122 and a second arm 123 located vertically above the first arm 122.

The second arm 123 connects the mirror assembly 120 to a door (not shown), but may be within the view of the driver of the vehicle (not shown). Therefore, the portion of the second arm 123 facing toward the driver may restrict line-of-sight of the driver.

The mirror assembly 120 includes a housing 126 surrounding a mirror pane (hidden from view). The housing 126 includes portions of the first arm 122 and the second arm 123. A first panel 132 faces generally forward, and somewhat outward, and a second panel 134 faces toward the driver of the vehicle. The first panel 132 and the second panel 134 are formed as separate pieces or components, which are then attached to assemble the housing 126 (i.e., the housing 126 is not formed as one piece).

The first panel 132 may be covered with a first coating, but the total reflectance of the first panel 132 and the first coating is less than one hundred percent and the transmittance is greater than zero. The first coating is reflective and may be, for example, chrome or aluminum. The second panel 134 may be covered with a second coating or the second panel 134 may be uncoated. The second coating may also be a thin layer of chrome or aluminum. Whether coated or uncoated, the total reflectance of the second panel 134 is less than the reflectance of the first panel 132.

Therefore, light from outside of the vehicle passes through the first panel 132 and the second panel 134 to the interior of the vehicle. However, when viewed from outside of the vehicle, the housing 126 appears to be reflective. The combined, or total, reflectance of the first coating, the first panel 132, the second coating (if present), and the second panel 134 is less than one hundred percent and the transmittance or transmission value is greater than zero.

In some configurations of the mirror assembly 120, the first arm 122 and the second arm 123 may essentially merge into one large arm that connects the housing 126 to the vehicle. In such a configuration, the second panel 134 would form all portions of the housing 126 facing the driver and the interior of the vehicle.

The detailed description and the drawings or figures are supportive and descriptive of the invention, but the scope of the invention is defined solely by the claims. While some of the best modes and other embodiments for carrying out the claimed invention have been described in detail, various alternative designs, configurations, and embodiments exist for practicing the invention defined in the appended claims.

1. A mirror assembly for a vehicle, comprising:
a mirror pane facing rearward, relative to the vehicle; and
a head cap having:
a first panel facing forward, relative to the vehicle, wherein the first panel is formed from a transparent material;
a first coating having a first reflectance and a first transmittance and substantially covering the first panel, wherein the first reflectance is less than one hundred percent and the first transmittance is greater than zero; and
a second panel facing an interior of the vehicle, wherein the second panel is formed from a transparent material, such that light passes through the first panel and the second panel and is visible from the interior of the vehicle.

2. The mirror assembly of claim 1, wherein a total reflectance of the first panel, the first coating, and the second panel is less than one hundred percent and a total transmittance is greater than zero.

3. The mirror assembly of claim 2, further comprising:
a second coating having a second reflectance and substantially covering the second panel, wherein the second reflectance is lower than the first reflectance.

4. The mirror assembly of claim 3, wherein a total reflectance of the first panel, the first coating, the second panel, and the second coating is less than one hundred percent and a total transmittance is greater than zero.

5. A mirror assembly for a vehicle, comprising:
a mirror pane facing rearward, relative to the vehicle; and
a housing formed from a transparent material having:
a first region facing forward, relative to the vehicle;
a first coating having a first reflectance and a first transmittance and substantially covering the first region, wherein the first reflectance is less than one hundred percent and the first transmittance is greater than zero; and
a second region facing an interior of the vehicle and having a second reflectance, wherein light passes through the first region and the second region and is visible from the interior of the vehicle.

6. The mirror assembly of claim 5, further comprising:
a second coating having a second reflectance and substantially covering the second region, wherein the second reflectance is lower than the first reflectance.

7. The mirror assembly of claim 6, further comprising:
an arm connecting the housing to the vehicle.

8. The mirror assembly of claim 7, wherein a total reflectance of the first region, the first coating, the second region, and the second coating is less than one hundred percent.

9. The mirror assembly of claim 8, wherein the first coating is one of chrome and aluminum.

10. A mirror assembly, comprising:
a mirror pane facing a first direction; and
a housing having:
a first region facing a second direction, different from the first direction, wherein the first region is formed from a transparent material;
a first coating having a first reflectance and a first transmittance and substantially covering the first region, wherein the first reflectance is less than one hundred percent and the first transmittance is greater than zero; and
a second region facing a third direction, different from the first direction and the second direction, wherein the second region is formed from a transparent material, such that light passes through the first panel and the second panel and is visible from the interior of the vehicle.

11. The mirror assembly of claim 10, wherein a total reflectance of the first region, the first coating, and the second region is less than one hundred percent and a total transmittance is greater than zero.
